(19) United States
(12) Patent Application Publication
(10) Pub. No.: US 2011/0122361 A1
(43) Pub. Date: May 26, 2011

(54) SUBSTRATE FOR DISPLAY DEVICE AND LIQUID CRYSTAL DISPLAY DEVICE

(75) Inventors: Tetsuo Fujita, Osaka-shi (JP); Takehiko Sakai, Osaka-shi (JP); Dai Chiba, Osaka-shi (JP); Kazunori Morimoto, Osaka-shi (JP); Yoshiharu Kataoka, Osaka-shi (JP)

(73) Assignee: SHARP KABUSHIKI KAISHA, Osaka-shi, Osaka (JP)

(21) Appl. No.: 13/055,144

(22) PCT Filed: Apr. 14, 2009
(86) PCT No.: PCT/JP2009/057490

§ 371 Date: Jan. 31, 2011

(30) Foreign Application Priority Data
Jul. 22, 2008 (JP) 2008-188635

(51) Int. Cl. G02F 1/1333

(52) U.S. Cl. 349/158

(57) ABSTRACT

The present invention provides a substrate for a display device and a liquid crystal display device, which are capable of preventing a reflective layer from being damaged in a resist separation step for patterning the reflective layer. The present invention is a substrate for a display device provided with a reflective layer in a display region, comprising: a pattern film that is disposed outside the display region except a terminal region and on the same side as a side of the reflective layer, the pattern film including either one of a material that has the same ionizability as a material of the reflective layer and a material that has higher ionizability than the material of the reflective layer.

### TECHNICAL FIELD

The present invention relates to a substrate for a display device and a liquid crystal display device. More particularly, it relates to a substrate for a display device and a liquid crystal display, which are suitable for a reflective liquid crystal display device and a transflective liquid crystal display device provided with a reflective layer.

### BACKGROUND ART

Liquid crystal devices are divided into three: a transmissive liquid crystal display device in which an image is displayed with a light source of a backlight or the like; a reflective liquid crystal display device in which an image is displayed by reflection of outside light; and a transflective liquid crystal display device in which an image is displayed by both a light source and outside light. Of these three, the reflective liquid crystal display device and the transflective liquid crystal display device are more advantageous than the transmissive liquid crystal display device due to their lower power consumption.

The reflective display device and the transflective liquid crystal display device each have a reflective layer formed with a metallic material with a high reflectance such as aluminum (Al) and silver (Ag). The reflective layer is usually formed by a photolithography method that easily realizes patterning with high precision.

Patent Document 1, for example, discloses a method of disposing a protective film pattern that is adjacent to a transparent electrode provided in a transmissive display region of a pixel and has a strip shape around the display region, as a technique for preventing electric corrosion between a transparent electrode and a reflective electrode. Patent Document 2, for example, further discloses a method of patterning a reflective electrode with a connection electrode covered with a photosensitive resin, as a technique for preventing the cell reaction between a connection electrode and a reflective electrode.

### [Patent Document 1]

Japanese Kokai Publication No. 2008-9082

### [Patent Document 2]

Japanese Kokai Publication Heill-72807

### SUMMARY OF THE INVENTION

However, in the method of forming a reflective layer by a photolithography method, the reflective layer is sometimes damaged (disappears, is dissolved, or the like) after a step of separating a resist for patterning the reflective layer with a resist-separating solution (resist separation step).

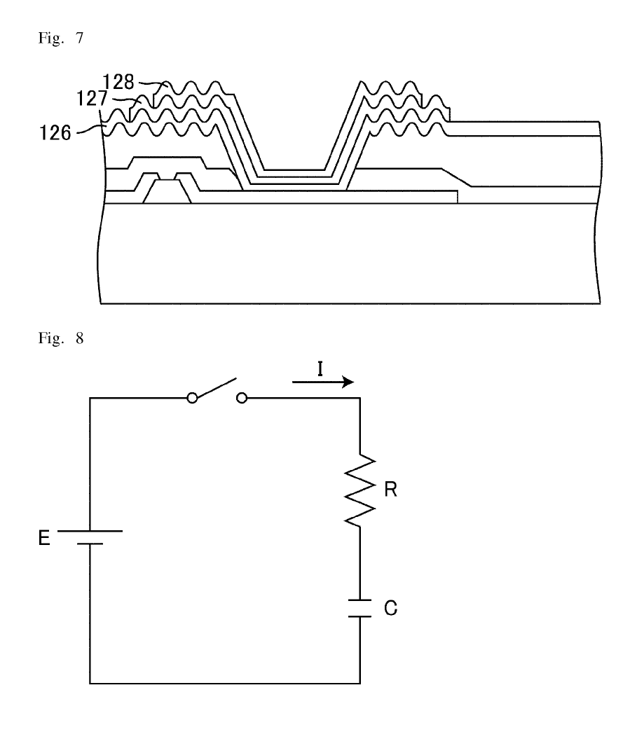

FIG. 6 is a plan view schematically illustrating a conventional substrate for a display device after a resist separation step. FIG. 7 is a cross-sectional view schematically illustrating a pixel of the conventional substrate for a display device after the resist separation step. Even if in the conventional substrate for a display device, a reflective layer 128 formed of Al or the like was patterned in the same manner as a conductive protective film 127 formed of Mo or the like and disposed underneath the reflective layer 128 so that the reflective layer 128 and the conductive protective film 127 had substantially the same size, the reflective layer 128 after the resist separation step was shifted by approximately several μm from the periphery of the end of the conductive protective film 127 and was smaller than the conductive protective film 127, as illustrated in FIG. 7. That is, the peripheral portion of the reflective layer 128 which should exist disappeared (was dissolved). In the development process of the reflective layer 128, when a developer passed through a pinhole of the reflective layer 128 or the like, a transparent conductive film 126 formed of ITO or the like and the reflective layer 128 simultaneously contacted the developer, and corrosion (galvanic corrosion) occurred. The conductive protective film 127 was provided to prevent the corrosion. Therefore, the disappearance (damage) of the reflective layer 128 was presumably attributed to a local cell between the transparent conductive film 126 and the reflective layers 128 in the development process of the reflective layer 128. In the conventional substrate for a display device, as illustrated in FIG. 6, the reflective layer 128 was not uniformly damaged in the entire region of the display region 111 with a plurality of pixels provided therein, and the reflective layer 128 was damaged particularly remarkably around the periphery of the display region 111 close to a frame region 112 and a terminal region 113 which were provided so as to surround the display region 111. In addition, the reflective layer 128 was particularly damaged on four corners of the display region 111 (shaded parts P in FIG. 6) around the periphery of the display region 111.

Patent Documents 1 and 2 do not prevent the reflective layer from being damaged in the resist separation step.

The present invention has been made in view of the above-mentioned state of the art. The present invention has an object to provide a substrate for a display device and a liquid crystal display device, which are capable of preventing a reflective layer from being damaged in a resist separation step for patterning the reflective layer.

### DISCLOSURE OF THE INVENTION

The present inventors have made various investigations on a substrate for a display device and a liquid crystal display device, which are capable of preventing a reflective layer from being damaged in a resist separation step for patterning the reflective layer. The present inventors have considered that in the conventional substrate for a display device, cell reaction may occur between the reflective layer and a mounting pad (connection electrode) for connecting a mounting member such as a driver IC chip and a flexible printed circuit (EPC) in the resist separation step.

As described above, the reflective layer is usually formed of Al, and the mounting pat is usually formed of ITO. Both the reflective layer and the protective film that are formed on the entire surface of the substrate are patterned in the development step, and the region provided with no resist for the reflective layer and the protective layer is removed after the development step. That is, in the resist separation step after the development step, the mounting pad formed of ITO is exposed. Further, the reflective layer can be electrically connected to the mounting pad via a source wiring or a gate wiring. As a result, the conventional substrate for a display device presumably shows a circuit configuration in the resist separation step as illustrated in FIG. 8. FIG. 8 is a view schematically illustrating a circuit formed by the reflective layer and the mounting pad in the resist separation step. In FIG. 8, E indicates electromotive force (potential difference between the reflective layer and the mounting pad), R indicates resistance (wiring resistance, etc.), C indicates a capacity of a capacitor element made of a gate wiring or a source wiring and a drain wiring. Immersion of the substrate for a display device in a separating solution that functions as an electrolyte (upon resist separation) means switching on. In such a circuit, a transient phenomenon in which the voltage and current are unstable occurs upon switching on and off.

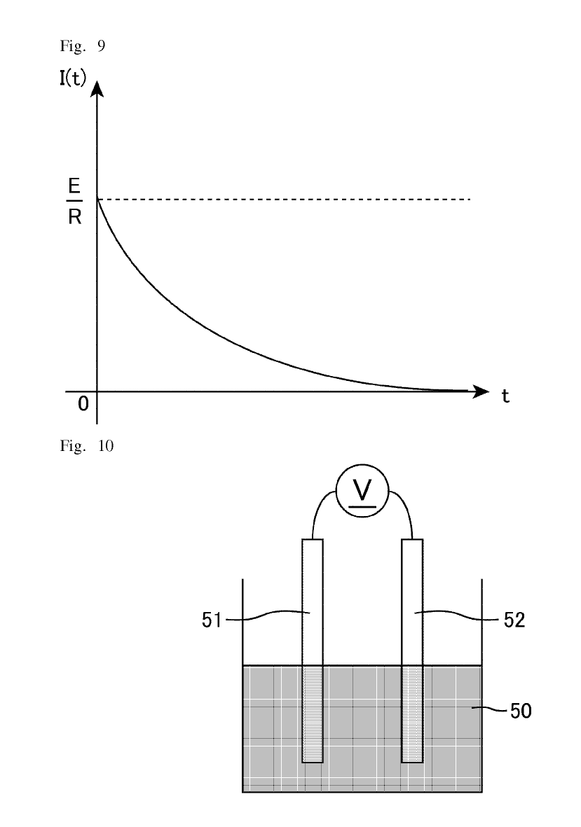

FIG. 9 is a graph showing the relationship between time and current that passes when a transient phenomenon occurs upon switching on. In the graph of FIG. 9, the horizontal axis and the vertical axis show a time t and a passing current I, respectively. The current obtained by dividing the electromotive force E by the resistance R runs upon switching on. The capacitor element C is charged as time passes, whereby the current I decreases. Thus, it is presumed that as a result of the transient phenomenon that occurs between the reflective layer and the mounting pad, the cell reaction arose between the reflective layer and the mounting pad in the resist separation step, leading to the damage of the reflective layer.

This transient phenomenon is a reaction that occurs in a very short period of time until the potential of the capacity C reaches equilibrium. In addition, the exchange (reacting dose) of electrons in the transient phenomenon is a relationship dependent on the distance between the reflective layer and the counter electrode (corresponding to the mounting pad in the terminal region in this case). Accordingly, as illustrated in FIG. 6, it is considered that the reflective layer 128 was damaged particularly remarkably around the periphery of the display region 111 partially because of this relationship.

As a result of further investigations, the present inventors focused on providing a pattern film on a substrate for preventing disappearance (dissolution) of the reflective layer in the resist separation step. The present inventors have found that the reflective layer can be prevented from being damaged in the resist separation step by disposing a pattern film in the region except the display region and the terminal region, the pattern film including either one of a material that has the same ionizability as a material of the reflective layer and a material that has higher ionizability than the material of the reflective layer. As a result, the above-mentioned problems have been admirably solved, leading to completion of the present invention.

That is, the present invention is a substrate for a display device provided with a reflective layer in a display region, comprising: a pattern film that is disposed outside the display region except a terminal region and on the same side as a side of the reflective layer, the pattern film including either one of a material that has the same ionizability as a material of the reflective layer and a material that has higher ionizability than the material of the reflective layer. As a result, in the resist separation step, the pattern film can be damaged preferentially compared with the reflective layer, and the reflective layer can be prevented from being damaged.

In the present description, the reflective layer has at least the function of reflecting light (light reflection function). The reflective layer may be a reflective electrode that further has the function of an electrode applying voltage to a liquid crystal layer (electrode function). The configuration of the reflective electrode is not particularly limited. Examples thereof include a structure of a monolayer having the reflection function and the electrode function, a structure in which a layer having the reflection function and the electrode function and a layer having the electrode function are laminated, and a structure in which a conductive protective film is disposed between a layer having the reflection function and the electrode function and a layer having the electrode function.

The ionizability used herein is ionizability in a separating solution to be used in the resist separation step. As the method of determining the ionizability, there may be mentioned a method of potential measurement of a thin film material (material of a pattern film) by the use of a silver-silver chloride electrode as a reference electrode. FIG. 10 is a view schematically illustrating potential measurement of a thin film material. As illustrated in FIG. 10, when a reference electrode 51 and a thin film material 52 are immersed in an electrolyte 50, and the potential difference between the reference electrode 51 and the thin film material 52 is measured, the ionizability of the thin film material 52 can be determined. The electrolyte 50 is a solution containing an electrolyte, and the kind thereof is not particularly limited. It is preferable to use the same kind of solution as an internal solution (reference solution) of the reference electrode 51. As a result, the internal solution of the reference electrode 51 can be prevented from being contaminated.

Table 1 shows the results obtained by measuring Al, Mo, and ITO as the thin film material 52 with the use of 3.3 mol/l of a KCl solution as an electric field liquid 50 and a silver-silver chloride electrode (HS-205C, produced by TOA CORPORATION) as the reference electrode 51. Table 1 shows the results upon measurement at an ordinary temperature (25° C.). The measurement was made by connecting the positive side of a voltmeter to the thin film material 52 and the negative side thereof to the reference electrode 51.

TABLE 1

| Thin film material | Measured value [V] |
|---|---|
| Al | −0.8 |
| Mo | −0.08 |
| ITO | 0.35 |

Table 1 shows that among Al, Mo, and ITO, Al is a material that has the lowest potential and therefore has the highest ionizability. Thus, the ionizability of the thin film material can be determined by measuring the potential difference between the reference electrode and the thin film material. Accordingly, the ionizability can also be determined depending on a normal electrode potential of the thin film material.

The same ionizability used herein means that a material has substantially the same ionizability as that of another material, and has approximate ionizability to that to such an extent that the effects of the present invention can be exerted. That is, the ionizability of the material of the pattern film may be somewhat different from the ionizability of the material of the reflective layer.

The pattern film is disposed outside the display region except the terminal region, and can be usually disposed in a frame region provided around the display region. The terminal region is usually provided outside the frame region. That is, the frame region is provided between the display region and the terminal region. The substrate for a display device of the present invention comprises the display region in which the reflective layer is disposed, the frame region provided outside the display region, and the terminal region provided outside the frame region. The substrate for a display device has a pattern film that is disposed on the same side as a side of the reflective layer, the pattern film including either one of a material that has the same ionizability as a material of the reflective layer and a material that has higher ionizability than the material of the reflective layer.

The configuration of the substrate for a display device of the present invention is not particularly limited as long as it essentially includes such components. The substrate for a display device may or may not include other components.

Preferable embodiments of the substrate for a display device of the present invention are mentioned in more detail below. The following embodiments may be employed in combination.

It is preferable that the pattern film is disposed outside four corners of the display region. As described above, the damage of the reflective layer is significant on four corners of the display region. Accordingly, when the pattern film is disposed outside four corners of the display region, the reflective layer can be efficiently prevented from being damaged. When the substrate for a display device is viewed in a plan view, the frame region is usually provided outside the display region. Therefore, it is preferable that the pattern film is provided in the frame region outside four corners of the display region.

It is preferable that the pattern film is disposed so as to surround the display region. As a result, the reflective layer can be prevented from being damaged on the entire region of the display region. The pattern film is disposed so as to surround the display region. Its plane shape is not particularly limited, and a plane shape along the periphery of the display region is preferable. Thus, the region for forming the pattern film can be narrowed to realize a narrower frame region. When the substrate for a display device is viewed in a plan view, the frame region is usually provided outside the display region. Therefore, it is preferable that the pattern film is provided so as to surround the display region.

It is preferable that the pattern film has a plane shape comprising at least one of a stripe pattern and a dot pattern. As a result, the reflective layer can be more prevented from being damaged. The reflective layer and the pattern film are more likely to be damaged (eluted) on the end surface (surface substantially perpendicular to the substrate surface) than on the pattern surface (surface substantially horizontal to the substrate surface). Accordingly, when the plane shape of the pattern film contains at least one of the stripe pattern and the dot pattern, the area of the end face of the pattern film increases, and the reflective layer can be more prevented from being damaged. These patterns may be disposed regularly or irregularly.

The pattern film may include the same material as the material of the reflective layer. As a result, the reflective layer and the pattern film can be formed in the same step, and therefore the number of steps can be suppressed.

The present invention is also a liquid crystal display device comprising the substrate for a display device. The liquid crystal display device provided with the substrate for a display device in which the reflective layer is prevented from being damaged can improve the production yield and reduce its cost.

### EFFECT OF THE INVENTION

The present invention provides a substrate for a display device and a liquid crystal display device, which are capable of preventing a reflective layer from being damaged in a resist separation step for patterning the reflective layer.

### BRIEF DESCRIPTION OF THE DRAWINGS

### [FIG. 1]

FIG. 1 is a plan view schematically illustrating an active matrix substrate of Embodiment 1.

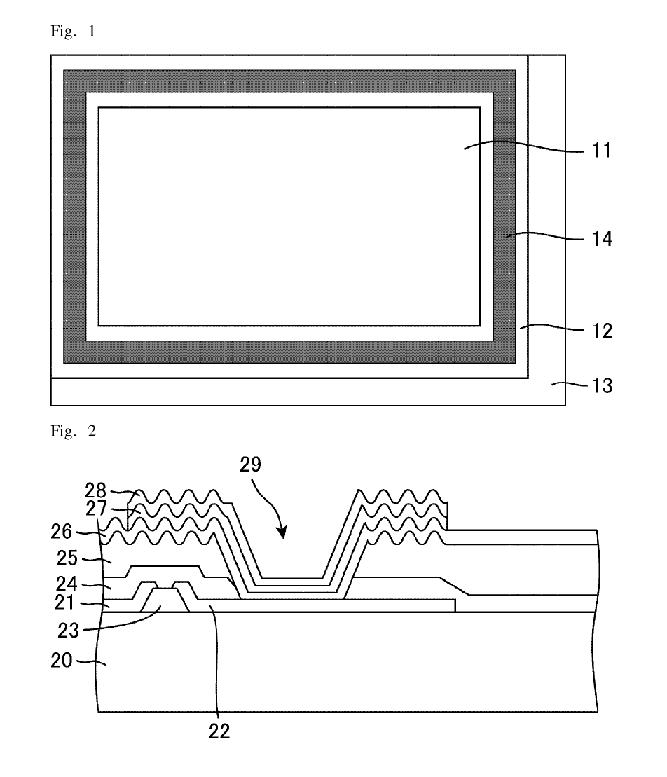

### [FIG. 2]

FIG. 2 is a cross-sectional view schematically illustrating a pixel of the active matrix substrate of Embodiment 1.

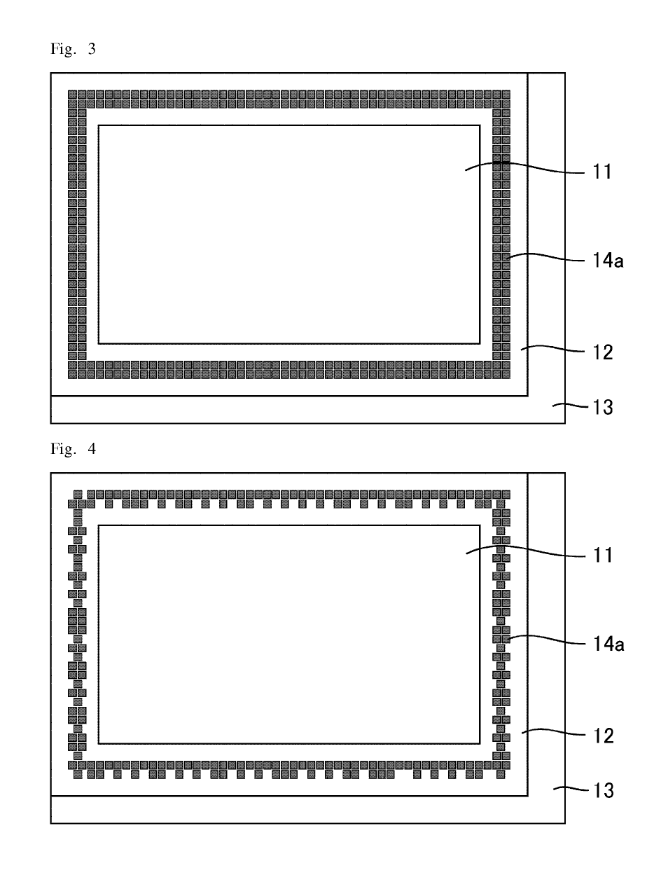

### [FIG. 3]

FIG. 3 is a plan view schematically illustrating an active matrix substrate of Embodiment 2.

### [FIG. 4]

FIG. 4 is a plan view schematically illustrating another active matrix substrate of Embodiment 2.

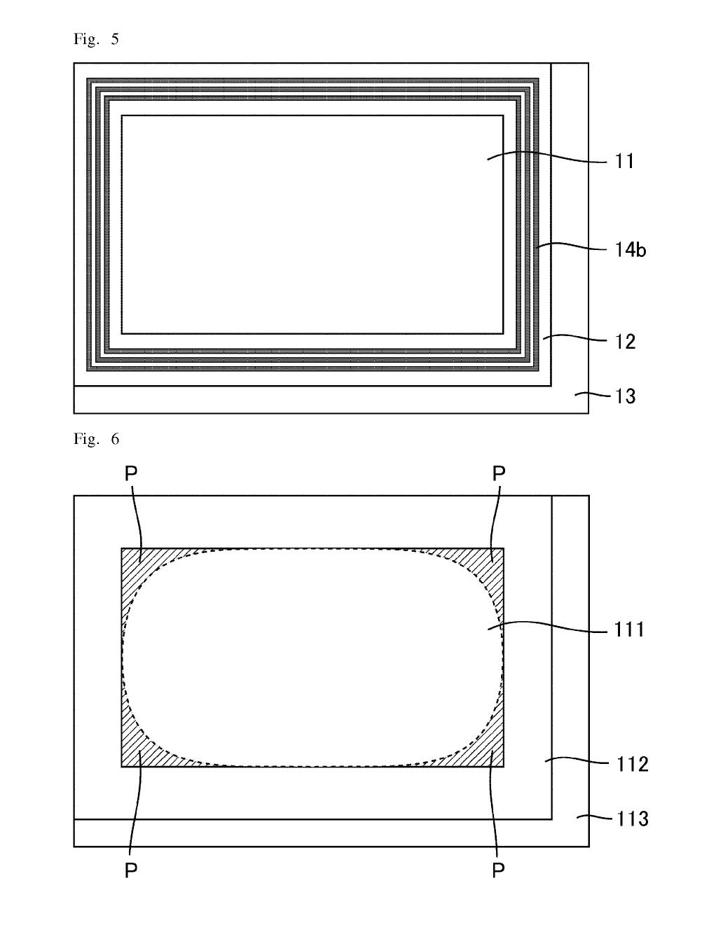

### [FIG. 5]

FIG. 5 is a plan view schematically illustrating another active matrix substrate of Embodiment 2.

### [FIG. 6]

FIG. 6 is a plan view schematically illustrating a conventional substrate for a display device after a resist separation step.

### [FIG. 7]

FIG. 7 is a cross-sectional view schematically illustrating a pixel of the conventional substrate for a display device after the resist separation step.

### [FIG. 8]

FIG. 8 is a view schematically illustrating a circuit formed by a reflective layer and a mounting pad in the resist separation step.

### [FIG. 9]

FIG. 9 is a graph showing the relationship between time and current that passes when a transient phenomenon occurs upon switching on.

### [FIG. 10]

FIG. 10 is a view showing potential measurement of a thin film material.

### PREFERRED EMBODIMENTS

The present invention will be mentioned in more detail referring to the drawings in the following embodiments, but is not limited to these embodiments.

### Embodiment 1

A transflective liquid crystal display device of

Embodiment 1 comprises an active matrix substrate (substrate for a display device) and a color filter substrate which face each other. The active matrix substrate and the color filter substrate are attached to each other with a sealing member, and a liquid crystal material containing liquid crystal molecules between both of the substrates to form a liquid crystal layer (liquid crystal cell).

FIG. 1 is a plan view schematically illustrating an active matrix substrate of Embodiment 1. The active matrix substrate of Embodiment 1 comprises a display region 11, a frame region 12 disposed so as to surround the display region 11, a terminal region 13 provided adjacent to the outside of the frame region 12, as viewed in a plan view. A drawing wiring that connects the display region 11 and the terminal region 13 is disposed in the frame region 12, and a pattern film 14 is disposed in a ring shape so as to surround the display region 11. The pattern film 14 has a continuous strip pattern and a plane shape along the periphery of the display region 11. A mounting pad for connecting a bank of an IC chip, a connection terminal of an FPC, or the like with a drawing wiring is disposed in the terminal region 13. A plurality of pixels is disposed in the display region 11. The pattern film 14 in a floating state is a member that does not function as an electrode and a wiring.

The active matrix substrate of Embodiment 1 is mentioned in further detail with reference to a cross-sectional view schematically illustrating pixels disposed in the display region 11. FIG. 2 is a cross-sectional view schematically illustrating a pixel of the active matrix substrate of Embodiment 1. As illustrated in FIG. 2, the active matrix substrate of Embodiment 1 has a thin film transistor (TFT) 23 connected to a source electrode 21 and a drain electrode 22 on a substrate 20, and has a passivation film 24 and an interlayer insulating film 25, which are disposed so as to cover the thin film transistor (TFT) 23, the source electrode 21, and the drain electrode 22. A transparent conductive film 26, a conductive protective film 27, and a reflective layer 28 are disposed on the interlayer insulating film 25 in this order from the substrate 20 side. The transparent conductive film 26, the conductive protective film 27, and the reflective layer 28 are electrically connected with the drain electrode 22 through the contact hole 29.

According to the present embodiment, the reflective layer 28 can be prevented from being damaged by disposing the pattern film 14 in the frame region 12. When the pattern film 14 is disposed in the frame region 12 in a ring shape so as to surround the display region 11, the reflective layer 28 in the entire display region 11 containing conventionally damage-sensitive four corners of the display region 11 can be prevented from being damaged. In addition, when the pattern film 14 has a plane shape along the periphery of the display region 11, the frame region 12 can be narrowed. Since the pattern film 14 has a continuous strip pattern, highly precise patterning is not necessary, and thereby a pattern film 14 can be formed easily.

The production method of the active matrix substrate of Embodiment 1 is mentioned below. First, the TFT 23, the source electrode 21, the drain electrode 22, the protective film 24, the interlayer insulating film 25, and the contact hole 29 were formed on the transparent substrate 20 such as a glass substrate. Subsequently, a transparent conductive material is formed on the entire surface of the substrate 20, and a resist was patterned so as to cover a region where the transparent conductive film 26 and a mounting pad were to be disposed, etching was performed with an etching solution, and thereby the transparent conductive film 26 and the mounting pad were formed. As the transparent conductive material, there may be mentioned an ITO (Indium Tin Oxide) film, a compound of indium oxide and tin oxide; and IZO (Indium Zinc Oxide) film, a compound of indium oxide and zinc oxide. ITO was used in the present embodiment. As a developer upon forming the transparent conductive film 26 and the mounting pad, an aqueous alkaline solution containing 2.38% by weight of TMAH (tetramethylammonium hydroxide) was used. The transparent conductive film 26 and the mounting pad each have a thickness of 100 nm. Thereafter, a resist on the transparent conductive film 26 and the mounting pad was removed with an amine separating solution. When the transparent conductive film 26 and the mounting pad were thus simultaneously formed with the same material, the increase in steps was prevented.

Next, a metallic material (in the present embodiment, Mo) having a standard electrode potential comparable to that of the transparent conductive film 26 was formed on the entire surface of the substrate 20, then a metallic material having a high reflectance was formed thereon, and a heating treatment was performed. As the metallic material having a high reflectance, there may be mentioned Al and Ag. Al was used in the present embodiment. Subsequently, a resist was patterned so as to cover a region where the reflective layer 28 and the pattern film 14 were to be disposed, etching was performed with an etching solution, and thereby the conductive protective film 27, the reflective layer 28, and the pattern film 14 were formed. As a result, patterning was performed so that the reflective layer 28 is overlapped with the transparent conductive film 26, and the reflective layer 28 and the pattern film 14 have the same plane shape as that of the conductive protective film 27. As a developer upon forming the reflective layer 28 and the pattern film 14, an aqueous alkaline solution containing 2.38% by weight of TMAH was used. The conductive protective film 27 had a thickness of 50 nm. The reflective layer 28 and the pattern film 14 each may have a thickness of 100 to 200 nm, and had a thickness of 100 nm in the present embodiment. The pattern film 14 had a width of about 1.0 mm. Both the distance between the pattern film 14 and the display region 11 and the distance between the pattern film 14 and the terminal regions 13 are about 1.0 mm when the substrate 20 was viewed in a plan view. When the reflective layer 28 and the pattern film 14 were thus simultaneously formed with the same material, the increase in steps was prevented.

In the present embodiment, the reflective layer 28 and the pattern film 14 were formed with the same material (Al in the present embodiment), but the reflective layer 28 and the pattern film 14 may be formed with different materials. The material of the pattern film 14 may have ionizability as high as or higher than that of the material of the reflective layer 28 and may be appropriately selected depending on the material of the reflective layer 28.

Finally, an active matrix substrate of Embodiment 1 was produced by removing a resist on the reflective layer 28 and the pattern film 14 with an amine separating solution. Since the reflective layer 28 and the mounting pad were thus formed with different materials, the reflective layer 28 may be damaged upon removal of the resist with the separating solution. However, in the present embodiment, this possibility can be avoided by preventing the reflective layer 28 from being damaged with the pattern film 14.

Thereafter, by using a conventional method, a color filter substrate was produced, the active matrix substrate and the color filter substrate were attached to each other, and a liquid crystal material was charged to produce a liquid crystal display device of Embodiment 1.

When the pattern film 14 was disposed in the frame region 12 in the liquid crystal display actually produced by the above processes, the reflective layer 28 were prevented from being damaged upon removal of the resist, and the region of the reflective layer 28 to be damaged were reduced. On the other hand, the pattern film 14 was damaged, and the peripheral portion was dissolved. That is, the end of the pattern film 14 was inside the end of the conductive protective film 27. Thus, the production yield of the liquid crystal display was improved.

### Embodiment 2

FIG. 3 is a plan view schematically illustrating an active matrix substrate of Embodiment 2. As illustrated in FIG. 3, in the present embodiment, a dot pattern in which a plurality of dots 14a was regularly arranged was used as a pattern film. The material and thickness of the dots 14a were the same as those of the pattern film 14 illustrated in FIG. 1. The width of the dot 14a was about 20 μm, and the distance between the dots 14a was about 10 μm. The use of such a dot pattern as a pattern film enabled further prevention of the damage of the reflective layer. Accordingly, in the liquid crystal display actually produced, the reflective layer was prevented from being damaged, and the region of the reflective layer to be damaged was reduced. As a result, the production yield of the liquid crystal display was further improved.

A modified embodiment of Embodiment 2 will be mentioned below.

FIG. 4 is a plan view schematically illustrating another active matrix substrate of Embodiment 2. As illustrated in FIG. 4, the dots 14a need not to be regularly arranged, and a dot pattern in which the dots 14a are irregularly arranged may be used. Even the use of such a dot pattern as a pattern film enabled further prevention of the damage of the reflective layer and further reduction in the region of the reflective layer to be damaged. As a result, the production yield of the liquid crystal display was further improved.

FIG. 5 is a plan view schematically illustrating another active matrix substrate of Embodiment 2. As illustrated in FIG. 5, a stripe pattern in which a plurality of strip patterns 14b is regularly arranged may be used as a pattern film. The material and thickness of the strip pattern 14b were the same as those of the pattern film 14 illustrated in FIG. 1. The use of such a stripe pattern as a pattern film enabled further prevention of the damage of the reflective layer and further reduction in the region of the reflective layer to be damaged. As a result, the production yield of the liquid crystal display was further improved.

The present invention has been thus mentioned in detail by way of the transflective liquid crystal display devices of Embodiments 1 and 2, but is not limited to these. The present invention may be applied to the transflective liquid crystal display device.

The present application claims priority to Patent Application No. 2008-188635 filed in Japan on Jul. 22, 2008 under the Paris Convention and provisions of national law in a designated State, the entire contents of which are hereby incorporated by reference.

### EXPLANATION OF NUMERALS AND SYMBOLS

11, 111: Display region
12, 112: Frame region
13, 113: Terminal region
14: Pattern film
14a: Dot
14b: Strip pattern
20: Substrate
21: Source electrode
22: Drain electrode
23: Thin film transistor (TFT)
24: Passivation film
25: Interlayer insulating film
26, 126: Transparent conductive film
27, 127: Conductive protective film
28, 128: Reflective layer
29: Contact hole
50: Electrolyte
51: Reference electrode
52: Thin film material

1. A substrate for a display device provided with a reflective layer in a display region, comprising:
a pattern film that is disposed outside the display region except a terminal region and on the same side as a side of the reflective layer, the pattern film including either one of a material that has the same ionizability as a material of the reflective layer or a material that has higher ionizability than the material of the reflective layer.

2. The substrate for a display device according to claim 1,
wherein the pattern film is disposed outside four corners of the display region.

3. The substrate for a display device according to claim 1,
wherein the pattern film is disposed so as to surround the display region.

4. The substrate for a display device according to claim 1,
wherein the pattern film has a plane shape comprising at least one of a stripe pattern and a dot pattern.

5. The substrate for a display device according to claim 1,
wherein the pattern film includes the same material as the material of the reflective layer.

6. A liquid crystal display device, comprising:
the substrate for a display device according to claim 1.

7. The substrate for a display device according to claim 1,
wherein the substrate for a display device includes a transparent conductive film,
at least part of the transparent conductive film is covered with the reflective layer.
